(19) United States
(12) Patent Application Publication
(10) Pub. No.: US 2009/0250245 A1
(43) Pub. Date: Oct. 8, 2009

(54) Cable Holding and Positioning Device

(76) Inventor: Steven E. Kwak, Lombard, IL (US)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/302,542

(22) PCT Filed: May 30, 2007
(86) PCT No.: PCT/US07/12767

§ 371 Date: Jun. 16, 2009

Related U.S. Application Data
(60) Provisional application No. 60/809,080, filed on May 30, 2006.

(51) Int. Cl. H02G 3/04; H01B 7/00; H01R 13/72

(52) U.S. Cl. 174/135; 29/745; 439/501

(57) ABSTRACT

A cable holding and positioning device is enclosed that comprises a tubular member having a first end and second end disposed opposite the first end and a cover disposed over the second end of the tubular member that includes a slit with an aperture. The cover secures one or more of a cable, a cord, and a connector that has entered the first end of the tubular member and passed through the second end, thereby preventing one or more of the cable, the cord, and the connector from passing back through the tubular member toward the first end. The tubular member and cover may comprise a heat resistant and fire retardant material.

### TECHNICAL FIELD

This disclosure relates generally to cable organization and management devices, and, more specifically, to a cable holding and positioning device.

### BACKGROUND OF THE INVENTION

Cable management and organization systems have been developed to help solve problems and inconveniences associated with maintaining cables or cords of common personal electronic devices, i.e., computers, mobile phones, MP3 players, and personal digital assistants. Specifically, power, sound, and computer cables associated with these electronic devices are typically strewn across desks, dressers, and countertops, for example. Gravity and limited weight on the end of the cable that connects into a device often cause a disconnected cable to slide away and become tangled with other cables. Cables that become misplaced from their intended position are not only a frustration to end users, but also a safety hazard.

Attempts have been made to organize and manage the cables of electronic devices. For example, many mobile phones include carriages for organizing and holding cables associated with the mobile phones, but these devices are specifically designed to only store mobile phones for charging, for example. Other cord or cable organizing devices include a cylindrical container for holding a bundled cord or cords, or a sheath, or a sleeve for organizing cords. See, e.g., U.S. Pat. No. 6,301,752; U.S. Pat. No. 6,425,165; U.S. Pat. No. 6,740,817; U.S. Pat. No. 6,916,992. However, such devices fail to provide means for adequately securing the cable or cord into the device, often causing the cables to slip and sometimes fall out of the devices.

Another limitation of the current cable holding devices is that they are not universal, but are typically designed for only one type of cord or cable use, such as a cell phone. As such, one may not use the device to accommodate a variety of other electronic or handheld devices. Current devices are also not designed for managing the cord only, but further store or manage other parts of the electronic device, for example. Further, other cable holding devices are designed primarily for an electronic device to only rest on and plug into for charging or power delivery and are not fashionable or usable as a display item. Still further, current cable holding devices are not designed to allow the cord or cable to be easily removed.

### SUMMARY OF THE DISCLOSURE

A cable holding and positioning device is disclosed that comprises a tubular member having a first end and a second end disposed opposite the first end and a cover disposed over the second end of the tubular member. The cover secures one or more of a cable, a cord and a connector that has entered the first end and passed through the second end, thereby preventing one or more of the cable, the cord and the connector from passing back through the tubular member toward the first end.

The tubular further comprises a flexible material allowing the tubular member to expand and contract depending upon the size of one or more of the cable, the cord, and the connector being inserted into the tubular member. The first end of the tubular member is an entrance for receiving one or more of a cable, a cord, and a connector and the second end of the tubular member is an exit through which one or more of the cable, the cord, and the connector extends. The tubular member further comprises a first ring attached to the first end and a second ring attached to the second end, both of which allow the tubular member to maintain its shape. The first and second rings comprise a heat resistant and flame retardant material.

The aperture is disposed at the center of the cover, is circular in shape, and provides enough room for the one or more of a cable, a cord, and a connector to pass through with minimal force and acts as a barrier of re-entry for one or more of the cable, the cord and the connector back into the tubular member. The aperture further secures one or more of the cable, the cord and the connector at the second end of the tubular member by wrapping around one of the cable and the cord and preventing one or more of the cable, the cord and the connector from sliding back through the tubular member.

The tubular member further comprises a cylinder having a flexible and expandable material, allowing one or more of a cable, a cord and a connector to pass through the first end, expand the first end temporarily, and then narrow the first end again as one or more of the cable, the cord and the connector passes therethrough. The flexible and expandable material of the cylinder further helps secure one or more of the cable, the cord and the connector once it reaches the second end of the cylinder, thereby preventing one or more of the cable, the cord and the connector from passing back through the cylinder.

The cable holding and positioning device further comprises a housing for receiving the tubular member and cover disposed over the second end of the tubular member. The housing is small enough in size to be placed on one or more of a desk, a countertop, and a dresser. The housing is shaped as one of a football, a baseball, a golf ball, a tennis ball, a sphere, a dog, a frog, a cat, a bear, a doctor bag, a nurse hat, a fire truck, an ambulance, a cross and a star.

The cable holding and positioning device comprises a combination of one or more of cloth, leather, vinyl, plastic, wood, or synthetic material that may be weighted by a filling material, such as foam, synthetic beans, or the weight of the holding and positioning device.

The tubular member and the cover disposed on the second end of the tubular member comprise heat resistant and fire retardant material.

In another embodiment of the disclosure, a molded cable holding and positioning device comprises a housing having a front portion, a rear portion and a central portion. An integral cylinder is disposed within the central portion and includes a first end and a second end, wherein the second end includes a slit having a center aperture. One or more of a cable, a cord and a connector is pushed through the first end of the cylinder and into the center aperture, such that the slit and center aperture prevent one or more of the cable, the cord, and the connector from passing back through the cylinder toward the first end.

In another embodiment of the disclosure, a cable holding and positioning device comprises a housing having a front portion and a rear portion and a C-shaped bore disposed within the housing and extending from the front portion to the rear portion. The C-shaped bore has a first portion for receiving one of a cable and a cord and a second portion for holding and preventing one of the cable and the cord from falling back through the C-shaped bore.

A method of making a cable holding and positioning device is also disclosed that comprises the steps of assembling a tubular member that includes a first end and a second end having a slit and an aperture for securing one or more of a cable, a cord and a connector, placing the tubular member within a housing, and fastening the tubular member to the housing.

### BRIEF DESCRIPTION OF THE DRAWINGS

Objects, features, and advantages of the present disclosure will become apparent upon reading the following description in conjunction with one or more of the following figures.

FIG. 1 is a front perspective view of a cable holding device according to the present disclosure;

FIG. 2 is a perspective view of a tubular member for the cable holding device of the present disclosure;

FIG. 3 is a perspective view of a second embodiment of the cable holding device of the present disclosure;

FIG. 4 is a front perspective view of a third embodiment of the cable holding device of the present disclosure;

FIG. 5 is a rear perspective view of the third embodiment of the cable holding device of the present disclosure having a cable disposed therein;

FIG. 6 is a front perspective view of a fourth embodiment of the cable holding device of the present disclosure;

FIG. 7 is rear perspective view of the fourth embodiment of the cable holding device of the present disclosure;

FIG. 8 is front perspective view of the fourth embodiment of the cable holding device of the present disclosure having the cable disposed therein;

FIG. 9 is a rear perspective view of the fourth embodiment of the cable holding device of the present disclosure having the cable disposed therein;

FIG. 10 is a front perspective view of a fifth embodiment of the cable holding device of the present disclosure;

FIG. 11 is a front perspective view of the fifth embodiment of the cable holding device of the present disclosure having the cable disposed therein;

FIG. 12 is a rear perspective view of the fifth embodiment of the cable holding device of the present disclosure;

FIG. 13 is side perspective view of the fifth embodiment of the cable holding device of the present disclosure;

FIG. 14 is a top perspective view of the fifth embodiment of the cable holding device of the present disclosure;

FIG. 15 is a bottom view of a sixth embodiment of the cable holding device of the present disclosure;

FIG. 16 is a side perspective view of the sixth embodiment of the cable holding device of the present disclosure;

FIG. 17 is a rear perspective view of the sixth embodiment of the cable holding device of the present disclosure;

FIG. 18 is a side perspective view of a seventh embodiment of the cable holding device of the present disclosure; and

FIG. 19 is a front perspective view of a housing for the seventh embodiment of the cable holding device of the present disclosure.

### DETAILED DESCRIPTION OF THE DISCLOSURE

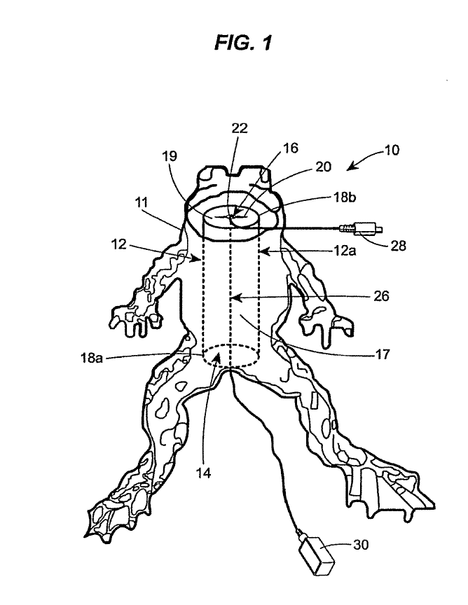

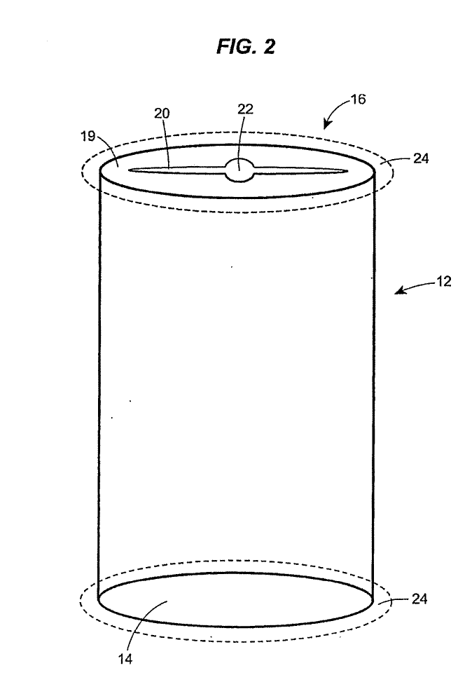

Referring now to FIG. 1, a weighted, fashionable cable holding device 10 is shown. The cable holding device is used to maintain a cable in a desired location, such as on a desktop, a dresser, a table, or a countertop. The cable holding device 10 includes a fashionable housing 11 in the shape of a frog and a tubular member generally in the form of a cylinder 12 disposed within the housing 11. The cylinder 12 includes a first end or entrance 14, a second end or exit 16 disposed opposite the first end or entrance 14, and a passageway 17 disposed between the entrance 14 and exit 16. The cylinder 12 receives a common cable or cord 26 through the entrance 14 and allows it to pass through to the exit 16. A first ring 18a is disposed at the entrance 14, and a second ring 18b is disposed at the exit 16 of the cylinder 12. The rings 18a, 18b may be made of plastic, rubber or metal and allow the cylinder 12 to maintain its shape. The rings 18a, 18b may be sewn to the cylinder 12 or attached via other means at an attaching location 24, as shown in FIG. 2, for example.

A cover 19, as best shown in FIG. 2, is disposed over the exit 16. The cover 19 includes a slit 20 disposed about three-quarters of the diameter of the cover 19 and a circular aperture 22 disposed at the center of the cover 19 to accommodate a variety of cable diameter sizes, for example, cables having diameters in the range of ⅛ to ¼ inches. The aperture 22 provides enough room for a cable connector 28 or cable 26 to pass through with minimal force and further acts as a barrier of re-entry for the cable connector 28 or cable 26 back into the cylinder. In other words, the aperture 22 in effect, latches, secures, grips or locks the cable 26 at the exit 16 of the cylinder 12 by wrapping around the cable 26 and preventing the cable 26 itself or the connector 28 attached to the cable 26 from unintentionally or inadvertently sliding back through the cylinder 12 of the cable holding device 10. Thus, the cable 26 is restricted at the exit 16 by the cover 19 and aperture 22 from passing back through the exit 16 without an intentionally applied forced or tug on the cable 26 from the first end 14 or entrance of the cylinder 12.

The cover 19 can be made of flame retardant and heat resistant material. Specifically, the cover 19 can comprise a braided, high temperature resistant polyethylene terephthalate monofilament material, as shown and described http://cableorganizer.com/fray-resistaint/#B. Alternatively, the cover may comprise a flame retardant thermoplastic polyurethane plastic or foam, a silicone rubber or rubber, or a cloth material with a chemical adhered thereto to make it flame retardant. An example of the flame retardant chemical is provided and described in http://www.fire-retardant.biz/.

The cylinder material is flexible and expandable, allowing cable connectors to pass through the narrow entrance 14, expand it temporarily, and then narrow it again as the connector passes through and the attached cable 26 follows. This expanding and narrowing (or contracting) feature of the cylinder 12 also assists in preventing the connector 28 or the cable 26 from passing back through the cylinder 12; in other words, in addition to the slit 20 and aperture 22, the flexible and expandable material of the cylinder 12 also helps secure or lock the cable 26 or cable connector 28 (or both) once the cable 26 or the cable connector 28 reaches the exit 16 of the cylinder 12. The cylinder material is not only flexible and expandable, it is also fire retardant and heat resistant.

As shown in FIG. 1, the cable 26 passes through the entrance 14 into the cylinder 12, which is placed at a back end of the frog housing 11 and exits the exit 16 disposed at a mouth of the frog cable holding device. The mouth is disposed at a front end of the frog housing. The exit 16 with the ring 18b and the cover 19 are all within the mouth of the frog housing 11, as shown in FIG. 1. Cable connector 28 and cable power outlet adapter 30 are also shown.

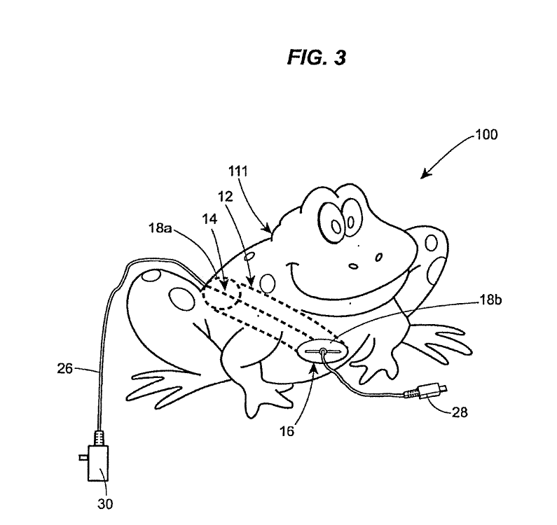

Referring now to FIG. 3, a second embodiment of a cable holding device 100 is shown that includes a fashionable housing 111 in the shape of a sitting frog. The cable holding device 100 includes the same cylinder 12 used in the cable holding device 10 described above and shown in FIGS. 1 and 2, for example. In this embodiment, however, the cylinder 12 is disposed within a central area of the cable holding device 100, and the entrance 14 is disposed at a back portion of the cable holding device 100. The exit 16 is disposed at a lower front portion of the frog cable holding device. Thus, the cable 26 first passes through the entrance 14 and exits at the exit 16 of the cylinder 12, as shown in FIG. 3. Cable connector 28 and cable power outlet adapter 30 are also shown in this embodiment.

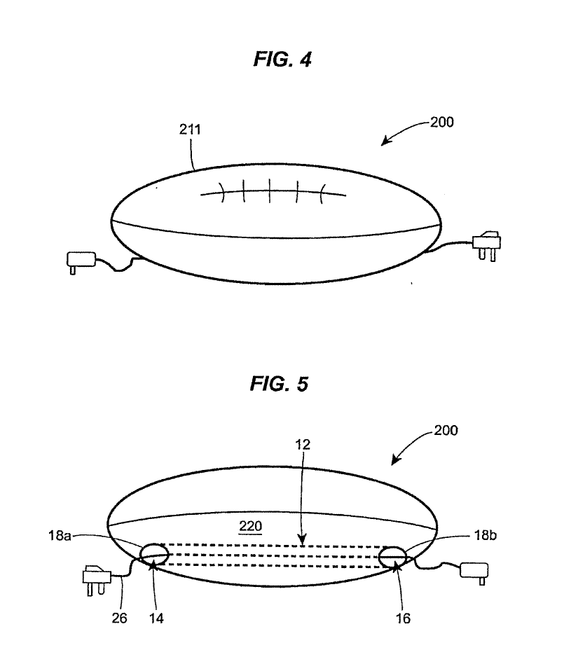

Referring now to FIGS. 4 and 5, a third embodiment of a cable holding device 200 is shown. As shown, this cable holding device 200 includes a housing 211 in the shape of a football and the same cylinder 12 used in the aforementioned cable holding devices 10, 100 (see FIGS. 1-3). In the cable holding device 200, the cylinder 12 is disposed at a lower back portion 220 of the device 200, as shown in FIG. 5. The cylinder 12 further includes the entrance 14 and exit 16 as well as rings 18a and 18b disposed at the entrance 14 and exit 16, respectively, and as also shown in FIG. 5. The cable 26 is inserted into the entrance 14 and pushed through until it reaches the exit 16. The cable 26 is then pulled out of the exit 14 and secured into place by a combination of both the slit 20 and aperture 22 (see FIG. 2, for example) and the flexible material of the cylinder 12.

As described above, each of the cable holding devices 10, 100, 200 includes a cylinder 12 that resides within a fashionable housing 11, 111, 211. The devices 10, 100, 200 are useful for personal and business use in maintaining cables or cords affiliated with common personal electronic devices such as computers, MP3 players, CD players, telephones, mobile telephones, laptop computers, personal digital assistants, and electronic personal gaming devices, which have cables, cords or cable connectors of various shapes and sizes.

Each of the cable holding devices 10, 100, 200 may be manufactured of any material. For example, the housings of the cable holding devices 10, 100, and 200 can be made of a combination of one or more of cloth, leather, vinyl, plastic, wood, or synthetic material that may be weighted by a filling material, i.e., foam, synthetic beans, or even the weight of the holding and positioning device itself.

As noted, the cylinder 12 in each embodiment can be made of fire retardant and heat resistant material. More specifically, the cylinder may comprise a braided, high temperature resistant polyethylene terephthalate monofilament material, as shown and described http://cableorganizer.com/fray-resistant/#B. This same fire retardant and heat resistant material may run through the center of the rings 18a, 18b at each end of the cylinder 12, such that the material is rolled back over the rings 18a, 18b and then attached to the rings 18a, 18b by sewing, for example. Other means of attaching the heat resistant and flame retardant material to the rings may also be provided that is consistent with the scope of this disclosure.

The cylinder may alternatively comprise a flame retardant thermoplastic polyurethane material, or rubber or silicone material that is inserted into a plush housing, for example.

Each of the cable holding devices uses a paperweight concept to hold cables in place and provides a fashionable device which securely holds a cable, keeps it organized and sometimes hides it from view while not in use, while keeping it at its intended point of placement.

While the embodiments 10, 100, and 200 show the cylinder 12 for a cable 26 (with connector) placed in a frog and football-type devices, the cylinder 12 may be designed and placed in various other forms of fashionable weighted devices to hold and position the cable 26. Such devices may be in the shape of or have housing in the shape of other sports balls, such as a basketball, a baseball, a tennis ball, or a golf ball, for example; other miniature animals, such as a dog, puppy, kitten, or lion, for example; or any other desktop display items without departing from the spirit or scope of this invention. Each of these fashionable cable holding devices may be displayed on a user's desk, dresser, or countertop, for example, and may be designed and tailored to the personal likes of the user (i.e., it may be an item which would be desired by an end user to display on their desk, dresser, or countertop).

The size of the cylinder 12 may vary without departing from the scope of the invention, but the width or diameter ultimately depends on the width or diameter of the cable, cord or connector, and the length ultimately depends upon the amount of pass-through length required for the cylinder 12 to extend from the entrance point 14 to the exit point 16 of the device in which it is installed.

After the cylinder 12 is assembled, the cylinder 12 is then placed inside of the housing 11, 111, 211 of the cable holding device and sewn or otherwise attached to the housing at the preferred entrance 14 and exit 16 of each of the embodiments disclosed. Each of the finished cable holding devices 10, 100, 200, thus, includes two holes, one for the cable 26 to enter the enclosed cylinder 12, and one, having a cover, for the cable 26 or cord or connector 28 to exit. Alternatively, the cylinder 12 may be a molded rubber or silicone rubber, or plastic material, such as flame retardant thermoplastic polyurethane plastic or foam that is placed inside the plush housing, for example.

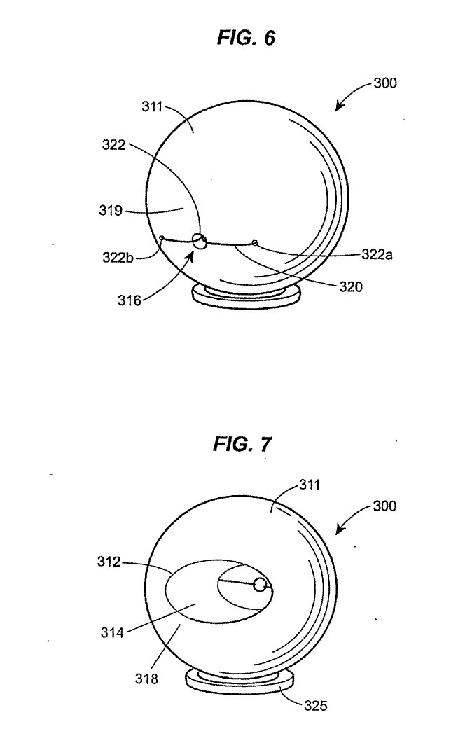

Referring now to FIGS. 6 and 7, a fourth embodiment of a cable holding device 300 is shown. The cable holding device 300 is a molded spherical ball and includes an integral cylinder 312 for receiving a cable such as 26. Instead of being separately attached or sewn to the housing of a cable holding device, the cylinder 312 is an integral part of the cable holding device 300 in that it is already molded into the housing 311. The device 300 is made of rubber, but may also be made of a variety of materials, such as plastic or various polymers and polymer like substances capable of being easily molded. In any case, the material used to make the device 300 is heat resistant and fire retardant material.

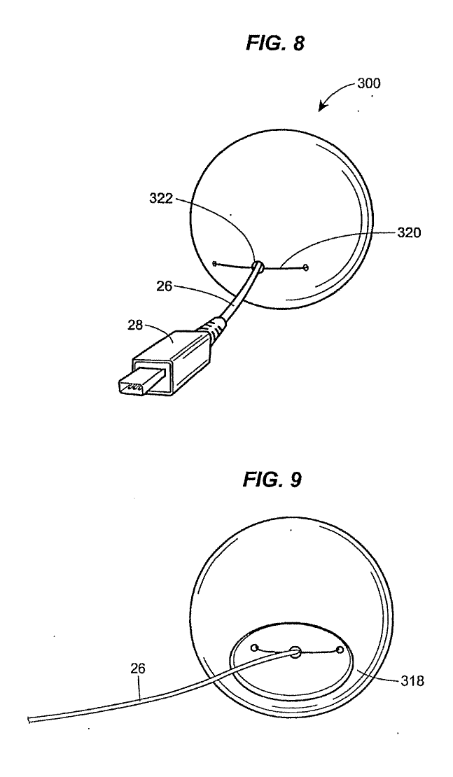

The cylinder 312 of the cable holding device 300 further includes an entrance 314 disposed on a rear portion 318 of the housing 311 and an exit 316 disposed on a front portion 319 of the housing 311. The exit 316 may be closed and include a center aperture 322 and a first side aperture 322a disposed on a first side of the center aperture 322 that is slightly smaller than the center aperture 322, as shown in FIG. 6. The exit 316 may further include a second side aperture 322b disposed on a second side of the center aperture 322, adjacent to the center aperture 322 and essentially the same size as, but opposite the first side aperture 322a. A slit 320 is created from the center aperture 322 to both the first side aperture 322a and the second side aperture 322b to allow the housing material to separate when a cable, or cord, or connector is pushed therethrough from the rear portion 318 of the housing 311. The cable such as 26 and connector such as 28 are secured in place by the slit 320 and center aperture 322, as shown in FIGS. 8 and 9.

Alternatively, the exit 316 may be molded such that it is open like the entrance 314. In this alternative, a plug may then be used to close the exit 316 of the cylinder. The plug would include the same center aperture 322, the same first and second side apertures 322a, 322b, and slit 320, as described above. The plug may comprise a flame retardant thermoplastic polyurethane plastic or foam, a silicone rubber or a rubber material.

As shown in FIG. 7, the cable holding device 300 may further include a weighted bottom 325 to provide additional stability for the device 300 when positioned on a desktop or counter, for example. Whether the weighted bottom 325 is used depends upon the type of rubber material used to make the device 300, as some rubber materials are more pliable, but not as heavy as other rubber materials.

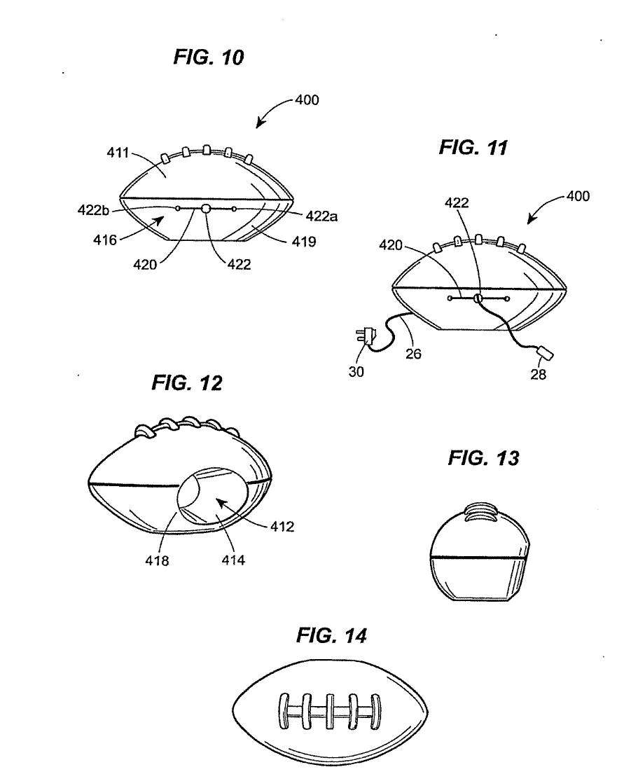

Referring now to FIGS. 10-14, a fifth embodiment of a cable holding device 400 is shown. Like the molded cable holding device 300 shown in FIGS. 6-9, the cable holding device 400 is also a molded, rubber device. In this embodiment, however, the cable holding device 400 includes a housing 411 having the shape of a fashionable football. The cable holding device 400 includes an integral cylinder 412 for receiving the cable such as 26. Instead of being separately attached or sewn to the housing of a cable holding device, the cylinder 412 is an integral part of the cable holding device 400 in that it is already molded into the housing 411.

The cylinder 412 of the cable holding device 400 includes an entrance 414 disposed on a rear portion 418 of the housing 411 and an exit 416 disposed on a front portion 419 of the housing 411. The exit 416 includes a center aperture 422 and a first side aperture 422a disposed on a first side of the center aperture 422 that is slightly smaller than the center aperture 422, as shown in FIGS. 10 and 11. The exit 416 further includes a second side aperture 422b disposed on a second side of the center aperture 422, adjacent to the center aperture 422 and essentially the same size as, but opposite the first side aperture 422a. A slit 420 is created from the center aperture 422 to both the first side aperture 422a and the second side aperture 422b to allow the housing material to separate when a cable, or a cord, or a connector is pushed therethrough from the rear portion 418 of the housing 411. The cable such as 26 and the connector such as 28 are secured into place by the slit 420 and center aperture 422, as shown in FIG. 11, for example.

Each of the molded devices 300, 400 is made of rubber, but can also be made of a variety of other materials, such as flame retardant thermoplastic polyurethane plastic or foam, silicone rubber, or various polymer like substances capable of being easily molded and known to persons of skill in the art. The material of the devices 300, 400 can also be heat resistant and fire retardant.

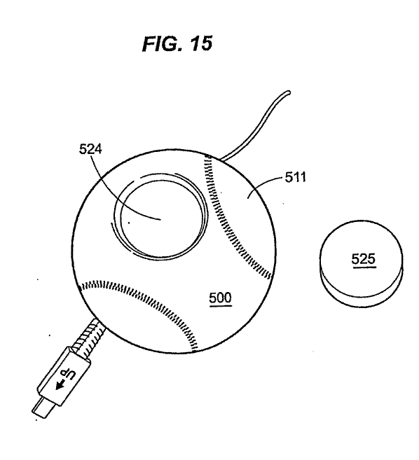

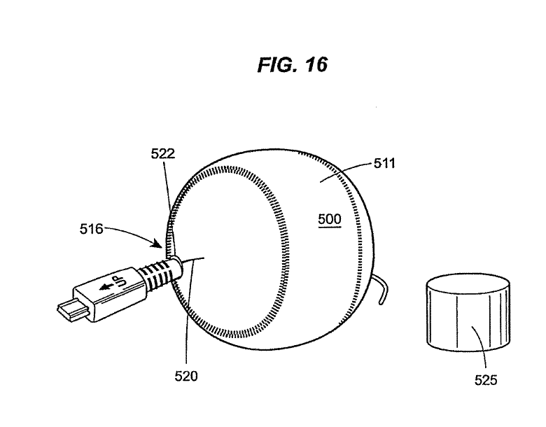

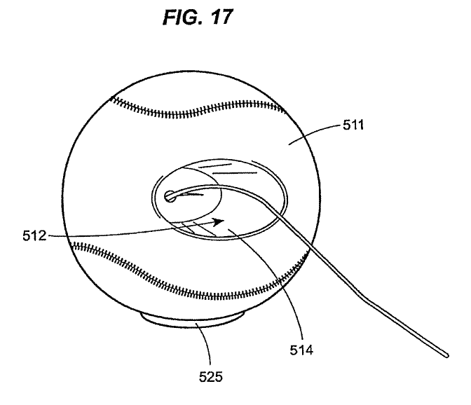

Referring now to FIGS. 15-17, a sixth embodiment of a cable holding device 500 is shown. The cable holding device 500 includes a molded plastic housing 511 in the shape of a fashionable baseball. The device 500 further includes essentially the same integral cylinder 412 used in the holding device 400 described above and shown in FIGS. 10-12, for example. Specifically, the device 500 includes a cylinder 512 (FIG. 17) having entrance 514 and an exit 516 (FIG. 16) having a center aperture 522 and a slit 420. The center aperture 522 and the slit 520 allow the housing material to separate when a cable or a cord or a connector is pushed therethrough from the rear portion of the housing 511. The cable and the connector are secured into place by the slit 520 and center aperture 522, as shown in FIG. 16, for example.

The cable holding device 500 further includes a metal weight 525, as shown in FIG. 15, for example. A bottom portion of the device 500 includes a molded aperture 524 (FIG. 15) for receiving the metal weight 525. The metal weight 525 is inserted into the aperture 524, as shown in FIG. 17, allowing the lighter plastic holding device 500 to remain in a desired position on a desktop or a table, for example.

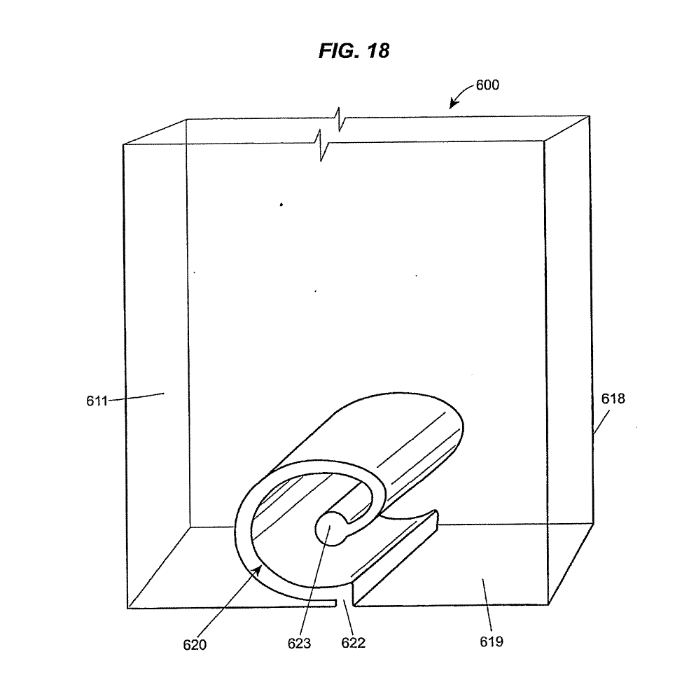

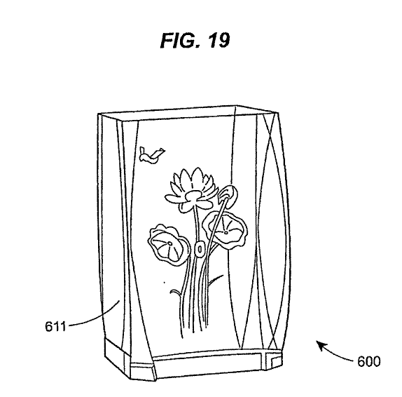

Referring now to FIGS. 18 and 19, a cable holding device may alternatively include a C-shaped bore 620, as opposed to a cylinder, as shown in FIG. 18. While the C-shaped bore 620 may be incorporated into a variety of cable holding devices having many different types of fashionable housings, the C-shaped bore 620 may be placed within a cable holding device 600 having a housing 611 made of crystal material that includes a decorative etching or design thereon (FIG. 19). The C-shaped bore 620 extends entirely through the cable holding device 600, i.e., from a front portion 619 to a rear portion 618. To place a cable or a cord within and through the cable holding device 600 having a C-shaped bore 620, a user sets a cable or a cord across an opening or first portion 622 of the C-shaped bore 620, lifts the cable or the cord from the front portion 619 and the rear portion 618 simultaneously, and loops the cable or the cord through the C-shaped bore 620. The cable or the cord then rests at a center aperture or second portion 623 (see FIG. 18) of the C-shaped bore 620, which includes a diameter of approximately ¼ of an inch. The user may slide the cable out the front portion 619 as needed for length and push it back when storing or hiding the excess cable. The housing 611 can be made of any heat resistant and fire retardant material available and known to persons of skill in the art, including those materials disclosed herein.

Each of the fashionable cable holding devices 10, 100, 200, 300, 400, 500, 600 is intended to be a desirable desktop, dresser, or countertop display item, for example, that prevents the cable, the cord or the connector, for example, from leaving its intended placement thereon. The devices 10, 100, 200, 300, 400, 500, 600 further eliminate end user frustration when searching for misplaced cables, prevent cable entanglement with other cables or items, and provide a safe environment for cable delivery.

Although certain cable holding devices have been described herein in accordance with the teachings of the present disclosure, the scope of the coverage of this patent is not limited thereto. Instead, this patent covers all embodiments of the teachings of the disclosure that fairly fall within the scope of permissible equivalents. Additionally, as will be appreciated by one of skill in the art, each of the cable holding devices may include various fashionable housing designs without departing from the scope of the disclosure. The fashionable housing designs include those having the shape of: (1) other sports items, e.g., baseballs, soccer balls, tennis balls, golf balls; (2) doll animals, e.g., dogs, kittens, and bears; (3) career items, e.g., doctor bags, nurse hats, fire trucks, ambulances; and (4) religious items, e.g., crosses, stars. All of the fashionable housing variations are typically small in size, which enables the cable holding devices to be easily placed on a desk, a countertop, or a dresser, for example.

We claim:

1. A cable holding and positioning device comprising:
a tubular member having a first end and a second end disposed opposite the first end; and
a cover disposed over the second end of the tubular member, the cover having a slit with an aperture;
wherein the cover secures one or more of a cable, a cord and a connector that has entered the first end and passed through the second end, thereby preventing one or more of the cable, the cord and the connector from passing back through the tubular member toward the first end.

2. The cable holding and positioning device of claim 1, wherein the tubular member comprises a flexible material allowing the cylinder to expand and contract depending upon the size of one or more of the cable, the cord, and the connector being inserted into the tubular member.

3. The cable holding and positioning device of claim 1, wherein the first end of the tubular member is an entrance for receiving one or more of the cable, the cord, and the connector and the second end of the tubular member is an exit through which one or more of the cable, the cord, and the connector extends.

4. The cable holding and positioning device of claim 1, wherein the tubular member further comprises a first ring attached to the first end and a second ring attached to the second end, both of which allow the tubular member to maintain its shape.

5. The cable holding and positioning device of claim 4, wherein the first ring and the second ring comprise a heat resistant and flame retardant material.

6. The cable holding and positioning device of claim 1, wherein the aperture is disposed at a center of the cover and is circular in shape.

7. The cable holding and positioning device of claim 1, wherein the aperture provides enough room for one or more of the cable, the cord and the connector to pass through with minimal force and acts as a barrier of re-entry for one or more of the cable, the cord and the connector back into the tubular member.

8. The cable holding and positioning device of claim 1, wherein the aperture secures one or more of the cable, the cord and the connector at the second end of the tubular member by wrapping around one of the cable and the cord and preventing one or more of the cable, the cord, and the connector from sliding back through the tubular member.

9. The cable holding and positioning device of claim 1, where the tubular member is a cylinder that comprises a flexible and expandable material, allowing one or more of the cable, the cord and the connector to pass through the first end, expand the first, end temporarily, and then narrow the first end as one or more of the cable, the cord and the connector passes therethrough.

10. The cable holding and positioning device of claim 9, wherein the flexible and expandable material of the cylinder further helps secure one or more of the cable, the cord and the connector once one or more of the cable, the cord and the connector reaches the second end of the cylinder, thereby preventing one or more of the cable, the cord and the connector from passing back through the cylinder.

11. The cable holding and positioning device of claim 1, further comprising a housing for receiving both the tubular member and the cover disposed over the second end of the tubular member.

12. The cable holding and positioning device of claim 11, wherein the housing is small enough in size to be placed on one or more of a desk, a countertop, and a dresser.

13. The cable holding and positioning device of claim 12, wherein the housing is shaped as one of a football, a baseball, a golf ball, a tennis ball, and a sphere.

14. The cable holding and positioning device of claim 12, wherein the housing is shaped as one of a dog, a frog, a cat, and a bear.

15. The cable holding and positioning device of claim 12, wherein the housing is shaped as one of a doctor bag, a nurse hat, a fire truck, and an ambulance.

16. The cable holding and positioning device of claim 12, wherein the housing is shaped as one of a cross and a star.

17. The cable holding and positioning device of claim 1, wherein the device comprises a combination of one or more of a cloth, leather, vinyl, plastic, wood, or synthetic material that may be weighted by a filling material, such as foam, synthetic beans, or the weight of the holding and positioning device.

18. The cable holding and positioning device of claim 1, wherein the tubular member comprises a heat resistant and flame retardant material.

19. The cable holding and positioning device of claim 1, wherein the tubular member comprises a heat resistant and flame retardant material.

20. A molded cable holding and positioning device comprising:
a housing having a front portion, a rear portion and a central portion; and
an integral cylinder disposed within the central portion, the cylinder having a first end and a second end, wherein the second end includes a slit having a center aperture;
wherein one or more of a cable, a cord, and a connector is pushed through the first end of the cylinder and into the center aperture, such that the center aperture and slit prevent one or more of the cable, the cord, and the connector from passing back through the cylinder toward the first end.

21. The molded cable holding and positioning device of claim 20, wherein the first end of the cylinder is an entrance for receiving one or more of a cable, a cord, and a connector, and the second end of the cylinder is an exit through which one or more of the cable, the cord, and the connector extends.

22. The molded cable holding and positioning device of claim 20, wherein the closed second end further includes a first side aperture and a second side aperture that further allow the second end to separate when one or more of the cable, the cord, and the connector is pushed therethrough from the rear portion of the housing.

23. The molded cable holding and positioning device of claim 20, further comprising a weighted bottom for providing additional stability for the device when placed on one or more of a desktop, a counter, and a dresser.

24. The molded cable holding and positioning device of claim 20, wherein the housing comprises a heat resistant and fire retardant material.

25. The molded cable holding and positioning device of claim 20, wherein the housing is small enough to be placed on one or more of a desk, a counter, and a dresser.

26. The molded cable holding and positioning device of claim 25, wherein the housing is shaped as one of a football, a baseball, a golf ball, a tennis ball, and a sphere.

27. The cable holding and positioning device of claim 25, wherein the housing is shaped as one of a dog, a frog, a cat, and a bear.

28. The cable holding and positioning device of claim 25, wherein the housing is shaped as one of a doctor bag, a nurse hat, a fire truck, and an ambulance.

29. The cable holding and positioning device of claim 25, wherein the housing is shaped as one of a cross and a star.

30. The cable holding and positioning device of claim 20, wherein the cylinder comprises a heat resistant and fire retardant material.

31. A cable holding and positioning device comprising:
a housing having-a front portion and a rear portion;
a C-shaped bore disposed within the housing and extending from the front portion to the rear portion, the C-shaped bore having a first portion for receiving one of a cable and a cord, and a second portion for holding and preventing one of the cable and the cord from falling back through the C-shaped bore.

32. The cable holding and positioning device of claim 31, wherein the housing comprises a heat resistant and fire retardant material.

33. The cable holding and positioning device of claim 31, wherein the C-shaped bore comprises a heat resistant and fire retardant material.

34. The cable holding and positioning device of claim 31, wherein the housing comprises one of a crystal, plastic, polyurethane, wood, rubber, and metal material.

35. A method of making a cable holding and positioning device comprising the steps of:
assembling a tubular member that includes a first end and a second end having a slit and an aperture for securing one or more of a cable, a cord, and a connector;
placing the tubular member within a housing; and
fastening the tubular member to the housing.

36. The method of claim 35, wherein the step of assembling the tubular member further comprises the steps of attaching a heat resistant and fire retardant first ring to a first end of the tubular member, and attaching a heat resistant and fire retardant second ring to a second end of the tubular member, thereby enabling the tubular member to maintain its shape after being placed within the housing.

37. The method of claim 35, further comprising the step of fastening the tubular member to the housing by sewing.

38. The method of claim 35, wherein the step of assembling the tubular member further comprises forming a molded plastic or rubber cylinder.

39. The method of claim 35, wherein the step of assembling the tubular member further comprises running fire retardant and heat resistant material through the first ring at the first end of the tubular member and the second ring at the second end of the tubular member, rolling the material back over the first ring and the second ring, and then attaching the material to the first ring and the second ring by sewing.

40. The method of claim 35, wherein the step of assembling the tubular member further comprises providing a heat resistant and fire retardant tubular member.
